(19) United States
(12) Patent Application Publication
(10) Pub. No.: US 2008/0067263 A1
(43) Pub. Date: Mar. 20, 2008

(54) Automated pest misting system with pump

(76) Inventors: Kemper O'neal Modlin, Spring, TX (US); Leo John Niekerk, Spring, TX (US)

Correspondence Address: RUDOLPH J. BUCHEL JR., LAW OFFICE OF, P. O. BOX 702526, DALLAS, TX, 75370-2526, US

(21) Appl. No.: 11/524,073

(22) Filed: Sep. 20, 2006

(51) Int. Cl. A01G 27/00

(52) U.S. Cl. 239/70; 239/331

(57) ABSTRACT

The present invention is directed to a system and method for safely and for efficient controlling adult populations of flying pests. A self-contained reservoir system for automated misting of pesticides (as opposed to merely spraying) is disclosed which can be operated in remote location without the availability of line power or pressurized water. The present automated spraying system comprises a secure controller unit with locking features, and a plurality of dispersing elements attached to the unit. Enclosed within the weatherproof and secure enclosure of the unit is a controller, pump, pesticide reservoir and power source for delivering controlled amounts of a pesticide mixture to the dispersing elements. The pump is capable of producing pressures sufficient for producing a mist from the dispersing elements. The pesticide reservoir holds pre-measured and premixed pesticide that can be used for direct treatment of an area. A misting schedule is entered into the controller, or timer. At the predetermined misting times, the controller completes the circuit between the battery and pump, thereby energizing the pump and causing the pesticide mixture to be pumped into the dispersing elements. The unit may be fitted with safety and efficiency components that automatically discontinue the misting cycles if someone is present in the area, weather conditions are not optimal, a fault is detected or pest activity is not favorable for a treatment.

### BACKGROUND OF THE INVENTION

The present invention relates generally to the automated misting of a pesticide product.

Manual insecticide sprayers have been known in the prior art since before 1900. These sprayers, while sometimes effective, are manually intensive. Often the results vary by the skill level of the operator and the amount of time the operator can devote to the chore of spraying of insecticides.

Automated insecticide spraying devices are also known in the prior art. These devices can be generally classified in two categories: human and agricultural and livestock applications. The amount of agricultural and livestock spraying insecticides is probably a magnitude greater than for human usage but the vast majority is under the human control. One of the more automated applications is demonstrated in U.S. Pat. No. 3,785,564 issued to Baldocchi on Jan. 15, 1974 which discloses an apparatus adapted to automatically travel between two rows of low plants, such as cotton plants, and dispense insecticide upward into the branches of the plants. The device is open-loop controlled by radio means.

U.S. Pat. No. Re. 31,023, issued to Hall on Sep. 7, 1982. Hall discloses a highly automated agricultural production system which include a mechanism for dispersing insecticides. With regard to only the spraying aspects, the system includes direct sensing means located within an agricultural production area, however the indirect sensing means are remotely located from the area being sensed. The sensing means work in concert to generate data on all important parameters in the homogeneous agricultural production area and is transmitted to a computing subsystem station for processing. The computing means correlates the direct and indirect data to generate appropriate instructions to accomplish a substantive number of functions for the agricultural production area. These include spraying insecticides through a fluid delivery subsystem. The field sensors, or remote sensors, or direct human observation, have sounded a trouble alert, and have given all the locations of the trouble. Several factors are considered before spraying. A timer indicates the required elapsed time since the last spray (several sprays may be needed to eliminate the pest) and the recent weather conditions, such as whether a heavy rain has washed off the last spray or if the wind velocity exceeds a prescribed value. The inventory levels of the liquid chemicals is verified and an assessment is make as to whether or not ample time exists before harvest to satisfy the legal residue requirements. If the decision is to spray, insecticide is mixed with water in a batch mixing tank that is common for all types of spraying, e.g., fertilizing, broadcasting herbicides and even planting by dispersing fine seeds.

U.S. Pat. No. 6,779,489, issued to Greeson on Aug. 24, 2004 discloses an automated pest sprayer for livestock. Greeson discloses variably discharging a mixture of carrier-based ingredients at different times, in differing rates, in different amounts, in varying spray patterns, either continuously, or in one or more interrupted sequences. Different spray patterns are proposed including a conventional substantially funnel-shaped spray pattern associated with nozzles, as well as a substantially focused stream or jet of a mixture of carrier-based ingredients and a random discharge from the system in order to reduce waste of expensive chemicals and lower the cost of pest control. The spraying operation is under the control of sensors that detect the position of livestock in a passageway and automatically trigger a precise spraying event based on the location of the animal.

Many devices for the automated spraying of insecticide in human applications are devoted to airborne insects and as such in U.S. Pat. No. 3,487,577 issued to Sexton on Jan. 6, 1970. Sexton discloses a sprayer with an elevated spray head with light sources and nozzles oriented toward the light projected from the light source. At predetermined intervals, the light sources are illuminated which attracts flying insects into the path of the insecticide mist, pumped from within a reservoir to the elevated spray head.

U.S. Pat. No. 4,671,435 issued to Stout on Jun. 9, 1987 discloses a dispensing system for periodically dispensing an airborne mist or spray of a chemical agent, such as an insecticide. The dispensing system comprises at least one supply of the chemical agent under pressure, and a spray head in communication with the supply of pressurized chemical agent. A solenoid valve is provided between the supply and the spray head for blocking and unblocking the flow of the pressurized chemical agent to the spray head for being spray dispensed. Stout also discloses a programmable means for energizing and de-energizing the solenoid valve for dispensing predetermined amounts of the chemical agent at predetermined times.

U.S. Pat. No. 5,660,330 issued to Scott on Aug. 26, 1997 discloses an automated pesticide applicator system including a pesticide storage receptacle having an aspirator, a conduit having a receiving end constructed to be attached to a water source and having a backflow valve to prevent the flow of water from the conduit to the source of water and to allow the flow of water in the opposite direction, a fluid control valve having an inlet end connected to the conduit and an outlet end connected to the aspirator, and a soaker tube attached to the aspirator. The soaker tube is generally positioned to surround a structure to be protected and is buried a shallow depth in the ground. The device employs an electrically operable valve and a timer/controller is coupled to the valve so as to control the operation of the valve.

U.S. Pat. No. 5,876,665 issued to Zalis on Mar. 2, 1999 discloses an apparatus for repelling insects. Insect repellent is drawn out of a vessel through a fitting and dispersed along a predefined boundary by a nozzle assembly including a distribution header and misting nozzles. The fitting is a venturi-like device. Pressurized fluid flows through the venturi-like device intermixing with the insect repellant prior to dispersement into the air. The fluid is pressurized water from a municipal source or private well.

### BRIEF SUMMARY OF THE INVENTION

The present invention is directed to a system and method for safely and for efficient controlling adult populations of flying pests. A self-contained reservoir system for automated misting of pesticides is disclosed (as opposed to merely spraying) which can be operated in remote location without the availability of line power or pressurized water. The present automated misting system comprises a secure controller unit with locking features, and a plurality of dispersing elements attached to the unit. Enclosed within the weatherproof and secure enclosure of the unit is a controller, pump, pesticide reservoir and power source for delivering controlled amounts of a pesticide mixture to the dispersing elements. The pesticide reservoir holds pre-measured and premixed pesticide that can be used for direct treatment of an area. A misting schedule is entered into the controller, or timer. At the predetermined misting times, the controller completes the circuit between the battery and pump, thereby energizing the pump and causing the pesticide mixture to be pumped into the dispersing elements. The unit may be fitted with safety and efficiency components that automatically discontinue the misting cycles if someone is present in the area, weather conditions are not optimal, a fault is detected or pest activity is not favorable for a treatment.

### BRIEF DESCRIPTION OF THE SEVERAL VIEWS OF THE DRAWINGS

The novel features believed characteristic of the present invention are set forth in the appended claims. The invention itself, however, as well as a preferred mode of use, further objectives and advantages thereof, will be best understood by reference to the following detailed description of an illustrative embodiment when read in conjunction with the accompanying drawings wherein:

FIG. 1 is a diagram of an automated insect sprayer as is known in the prior art;

FIGS. 2A and 2B are diagrams depicting a self-contained reservoir system for automated misting of pesticides, safely, for efficient control of adult populations of, for example, flying pests in accordance with an exemplary embodiment of the present invention;

FIGS. 3A and 3B depict the structure of a self-contained reservoir system for automated misting in accordance with an exemplary embodiment of the present invention;

FIGS. 4A and 4B depict the structure of a suction tube for a reservoir used with a self-contained reservoir system for automated misting in accordance with an exemplary embodiment of the present invention;

FIG. 5 is a diagram of an exemplary timing sequence for misting operations in accordance with one exemplary embodiment of the present invention;

FIG. 6 is a diagram of an exemplary timing sequence for a misting in accordance with one exemplary embodiment of the present invention;

FIG. 7 is a diagram of logical elements which may be employed for achieving a controller self-check prior to a misting cycle;

FIG. 8 is a diagram of an exemplary timing sequence for the intelligent scheduling of a misting sequence in accordance with one exemplary embodiment of the present invention; and

FIG. 9 is a diagram of a self-contained reservoir system using an injector for the automated misting of pesticides, safely, for efficient control of pests in accordance with an exemplary embodiment of the present invention.

Other features of the present invention will be apparent from the accompanying drawings and from the following detailed description.

### DETAILED DESCRIPTION OF THE INVENTION

Element Reference Number Designations

100: automated spraying system
102: reservoir
110: pressurized water source
112: safety valve
114: check valve
120: dispersing elements
122: tubing
124: nozzles
132: solenoid valve
134: injector
136: programmable timer
138: internal battery
150: controller unit
152: enclosure
154: enclosure door
160: support structure
200: automated misting system
220: dispersing elements
222: tubing
224: nozzles
225: mist
250: controller unit
252: enclosure
260: storage area
262: storage area door (right)
264: storage area door (left)
272: solar recharge cell
274: weather sensor
275: motion sensor
300: automated misting system
302: reservoir
303: inlet tube
304: suction tube
306: filter
320: dispersing elements
322: tubing
324: nozzles
325: mist
330: controller unit
332: pump control switch
334: pump
335: keypad
336: programmable controller
337: display
338: battery
339: rotary switch
340: battery charger
341: charger A/C port
342: bus
343: external connector
344: reservoir bus connector
345: reservoir bus
350: controller unit
348: door switch
350: controller unit
351: mounting hole
352: enclosure
353: mounting fastener
354: door
356: hinges
358: door lock
359: locking latch
360: exposed external control panel
362: delay button
364: indicator lights
366: manual test switch (locking)
372: solar recharge cell
374: weather sensor
375: motion sensor
376: warning light
378: audible alarm
403: supply tube
404: suction tube
406: filter
408: agitator body
444: reservoir bus connector
445: reservoir bus
446: reservoir cap
447: fluid level sensor wire
448: low fluid sensors
449: reservoir cap
450: agitator motor
451: empty sensors
452: agitator impeller shaft
454: agitator impeller
456: agitator intake slots
458: agitator outlet
900: automated misting system
902: internal reservoir
903: refill cap/tube
904: suction tube
906: pesticide level
908: diluted strata
910: pressurized water source
911: injector to pump tubing
912: safety valve
914: check valve
922: tubing
924: nozzles
925: mist
934: pump
935: buttons
936: programmable controller
937: display
938: battery
940: battery charger
942: injector
950: controller unit
952: cabinet enclosure
954: door
956: drain valve

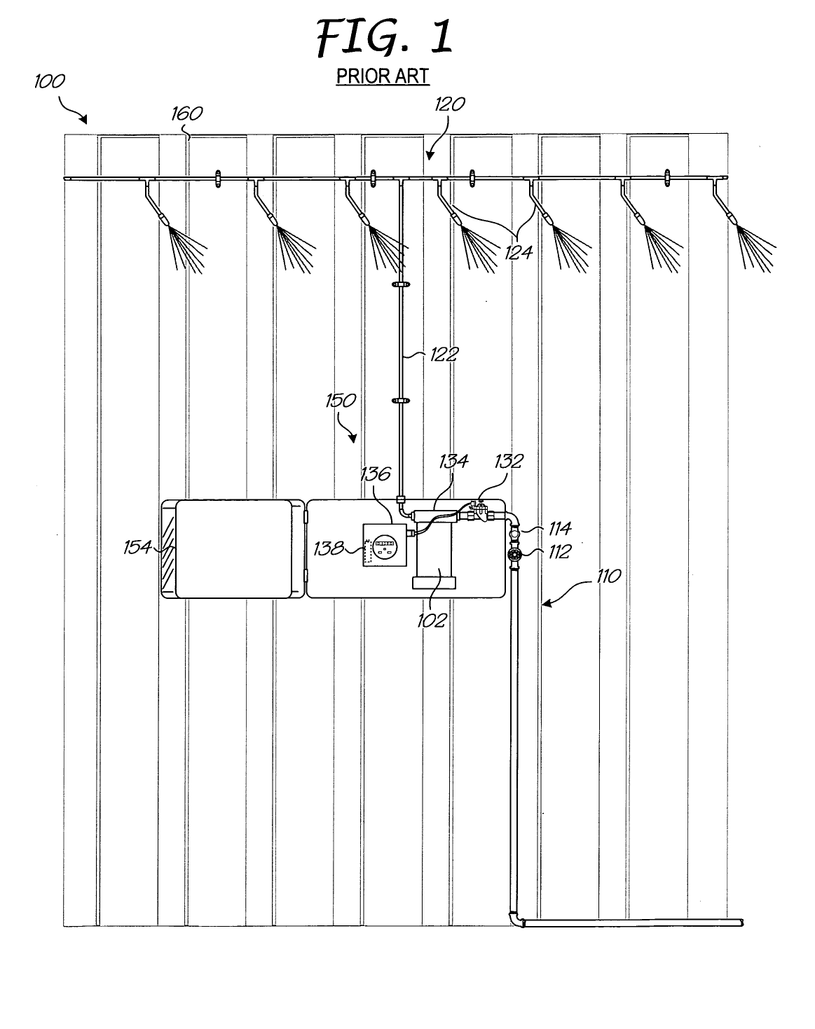

FIG. 1 is a diagram of an automated insect sprayer as is known in the prior art. Automated spraying system 100 is comprised of three primary components: pressurized water source 110, distribution and dispersing elements 120 and controller 130. Controller unit 150 generally comprises timer 136, which is electrically coupled to regulator and/or solenoid valve 132, and injector 134 which is hydraulically coupled between solenoid valve 132 and dispersing elements 120. Also depicted is reservoir 102 which, in accordance with the figure, is incorporated within injector 134. Reservoir 102 holds a relatively small volume of concentrated insecticide (for instance 15 fluid ounces). Pressurized water source 110 provides a pressurized water path to controller 130 and includes safety valve 112 and check valve 114 for protecting the water supply from an unintentional backflow and siphoning.

The components of controller unit 150 are enclosed in enclosure 152 with sealing door 154 which provides protection from the elements. Pressurized water from source 110 is received and regulated by solenoid valve 132. Solenoid valve 132 receives operating commands from timer 136 that signals an electrical solenoid to open a diaphragm flap in solenoid valve 132 and allow the pressurized water to flow into injector 134 (other types of valves are known and may also be employed). Injector 134 operates on the venturi principle wherein a fast moving stream of fluid creates a pressure drop and the resulting vacuum can be used to draw fluid into the fluid stream. Once energized, solenoid valve 132 allows the pressurized water to flow into injector 134, which, in turn, siphons a metered amount of concentrated insecticide from reservoir 102 that mixes with the stream of water. The insecticide mixture is then forced into tubing 122 by the water pressure, and on to nozzles 124 that are coupled into tubing 122. The force of the water pressure creates an insecticide spray as it egresses nozzles 124. The direction, pattern and amount of the insecticide spray are all regulated by the selection and orientation of the nozzles. Distribution and dispersing elements 120 are installed at a site in accordance with an optimal arrangement pattern to spray the site. For instance, tubing 122 and nozzles 124 may be installed on a permanent support structure such as fencing 160, with nozzles 124 elevated for controlling flying insects such as mosquitoes, noseeems (pronounced “no see ems”) and gnats.

The time and duration of spraying is controlled by timer 136. Timer 136 operates off power provided by a replaceable battery, usually a 9 volt battery, that is replaced whenever reservoir 102 is refilled with pesticide, ideally on a monthly basis. At setup phase, the operator selects an optimal time and duration for exterminating the types of unwanted pests that are present at the site. For instance, since many species of mosquitoes are more active in early morning and late evening hours, the operator may select spraying cycles that correspond to the activity cycle of the mosquito, i.e., for spraying in the early morning and late evening hours. The duration is also programmed at timer 136, but should be carefully adjusted to spray a predetermined volume of insecticide mixture, in accordance with the type of insecticide selected for the site and in compliance with the handling and use instructions for the particular insecticide being applied.

Because this particular type of spraying device relies on the pressurized water supply for the “pumping” force necessary for generating a spray, the power source required for operating the device is relatively small. Replaceable battery 138 need only provide enough energy to power solenoid valve 132 and run timer 136 for approximately one month between servicing. A typical 9 volt (a PP3 battery) normally provides sufficient energy to operate automated spraying system 100 for thirty or more days of two 15 second spray cycles.

Automated spraying system 100 has many advantages over prior art automated sprayers. It is relatively uncomplicated with few moving part to wear and breakdown. It has low power consumption and can run on a battery for days without replacement. Although it has a relatively small insecticide reservoir, the reservoir contains concentrated insecticide which requires little attention. The reservoir of concentrated insecticide is connected, via the injector, to an endless supply of water that does not need to be refilled. However, automated spraying system 100 has several traits that make it impractical for every application. For instance, automated spraying system 100 requires a pressurized water source to be located proximate to reservoir 102. Plumbing a water pipe to reservoir 102 may be impractical and even hazardous in high traffic areas. Perhaps more importantly, the performance of system 100 is limited by the water pressure at pressurized water source 110. Typically, municipal water systems limit the water pressure to 65 psi (pounds per inch²) in order to prevent damage to customers' valves, water heaters and appliances, and lessen the hydraulic stress on water mains and conduits. While automated spraying system 100 is suited for a residential environment, it is less well suited for operating in a commercial setting.

With regard to a commercial environment, flying insects are a persistent problem associated with the temporary storage of bio-waste awaiting pickup. Commonly, bio-waste materials, including for instance, contaminated and left over food products, preparation material and other types of bio and fecal matter, are temporarily stored in closed waste receptacles until the receptacles are emptied into a waste removal truck for transport to a sanitary landfill. If the commercial enterprise generating the refuse is in the business of preparing, storing or serving food products for the public, stringent sanitary guidelines apply to the storage, handling and removal of the refuse. Typically, the waste receptacles must be of a standardized and approved design with covers, and the covered containers must be located away from the food preparation and consumption areas. The distance between the food service area and the waste storage area depends on the site, but must be located such that they do not present a public health hazard or nuisance or interfere with the enjoyment of adjacent space, in non-urban areas the minimum distance is sometimes understood to be 50 feet from building entrances. Agricultural sites are often regulated less stringently than food preparation and service establishments, but fly populations associated with agricultural and ranching endeavors often extend well beyond the extent of the enterprise.

Excessive fly populations are obnoxious to farm workers, and can pose a serious public health problem when situated near human habitations. There are more than one hundred separate pathogens associated with the common house fly (Musca domestica Linnaeus). These pathogens may cause disease in humans and animals, including typhoid, cholera, bacillary dysentery, tuberculosis, anthrax ophthalmia and infantile diarrhea, as well as parasitic worms. Pathogenic organisms are picked up by flies from garbage, sewage and other sources of filth, and then transferred on their mouthparts and other body parts, through their vomitus, feces and contaminated external body parts to human and animal food. While the life span of an adult fly is usually only 15 to 25 days, the potential reproductive capacity of flies is tremendous. Each female fly can lay up to 500 eggs in several batches of about 75 to 150 eggs, each over a three to four day period. A pair of flies beginning breeding in April may be progenitors of 191,010,000,000,000,000,000 flies by August, if all the progeny were to live. Fortunately, this can never be realized.

Controlling fly populations at commercial sites is particularly difficult because of the amount of refuse being continually generated and the proximity to humans, either employees, customers or interlopers, limits the types of pesticide treatments that can be carried out safely. The prior art methodology for controlling the insects generally focuses on maintaining good sanitation rather than exterminating the pests. Manually broadcasting insecticides is simply not effective because the most efficient treatments should target the active adult populations. Manual spraying is at best a haphazard effort if undertaken by employees because the employees are often preoccupied with other tasks during periods of heightened fly activity. Additionally, the time an employee must spend away from her regular responsibilities amount to more than the time it takes for spraying an area, but also includes preparation and clean up times, as well as the time required for securing the pesticide spraying equipment away from the customers and the other employees. It is often simply impractical to schedule a spraying routine that coincides with the activity of adult flies without interfering with the employee's primary responsibilities. Commercial pest management services and exterminators are generally too expensive for providing daily treatments, unless the fly infestation is severe. Thus, the primary focus is on establishing and maintaining good sanitary practices, such as removing or isolating the waste food and bio-wastes from the egg-laying adult, thereby depriving the female of a breeding medium on which the flies can lay their eggs. Additionally, garbage cans and dumpsters used by a commercial establishment should have tight-fitting lids and be cleaned regularly of residue.

In warm weather the house fly can complete its life cycle in as little as seven days, therefore refuse should be removed at least twice a week. Removing refuse more than twice a week is usually not practical and is often not offered by the refuse removal service provider. However, even though the fly's life cycle can be interrupted by proper sanitation habits, as a practical matter it is impossible to eliminate the entire breeding environment for an entire life cycle. Some refuse is always missed which allows the adult fly population to rapidly reconstitutes itself. Even a relatively small population of adult flies can present a significant health hazard. In addition, typically, flies will find an unattended source of putrescence waste for breeding, from which the adults migrate to other sites. Adult fly populations may migrate from one refuse site to another and lay eggs throughout their lifecycles. Thus, killing the adult flies is the only solution to controlling an infestation and eliminating the health hazard associated with the adults.

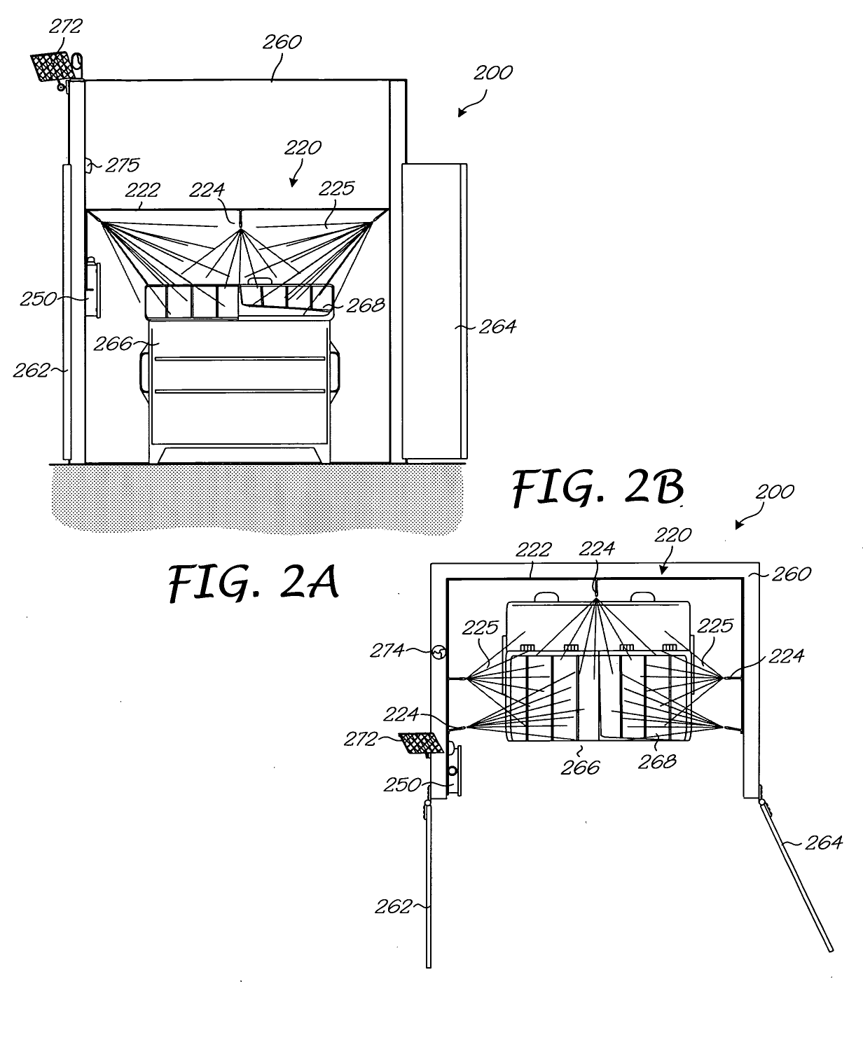

FIGS. 2A and 2B are diagrams depicting a self-contained reservoir system for automated misting of pesticides (as opposed to merely spraying), safely, for efficient control of adult populations of, for example, flying pests in accordance with an exemplary embodiment of the present invention. The present inventors understand that the prior art self-contained spraying systems can best be characterized as “spraying” systems rather “misting” systems because the particle size of the ejected pesticide is usually greater than 50 microns. The present inventors appreciate that what is necessary for effectively treating an area for flying pests is to fill the volume of the area with a suspended cloud of pesticide mist. A mist has fewer open spaces or gaps between particles than a spray, but is generally less dense and therefore will remain airborne longer than a spray particle. Mist infers that the diameter of the suspended liquid is generally between 30 microns and 50 microns. Therefore, in accordance with one exemplary embodiment of the present invention, the misting system utilizes a pump for increasing the pressure of the fluid at the nozzles to a level where misting is assured. Typically, a mist will be attained and can be maintained when the hydraulic pressure of the pesticide in the dispersion system is 100 psi or greater. Clearly, prior art systems that rely on pressurized water from municipalities cannot achieve and maintain misting because the pressure is below that necessary to create a mist.

Because the present system is self-contained, it may be utilized at sites without access to a pressurized water source or line power. Automated misting system 200 is typically situated in a dedicated refuse collection area where waste receptacles are maintained. A typical refuse collection area is a semi-secure location, usually bound by walls 260, but open, with a door or doors 262 and 264 for obstructing the view of the waste receptacle(s) located therein. As depicted in the figure, the receptacle may be mobile garbage bin (MGB 266) commonly, but improperly referred to as a “Dumpster” (which is a registered trademark of the Dempster company of Knoxville, Tenn.), with upper doors 268 for depositing refuse in the interior volume. Alternatively, other types of waste receptacle(s) my be employed within the refuse collection area, such as “wheelie” bins which generally have an internal volume of approximately 55 gallons, or even common trash/garbage cans with somewhat lesser internal volumes.

Automated misting system 200 mists the refuse collection area with a pesticide or a combination pesticide and fragrance at times when the adult flying pests are most active. That is not to say that pesticide mist 225 is not effective on crawling pests, it is, however, one advantage of the present invention over the prior art in its ability to dispense the pesticide at a time and in the vicinity of the active adults. Thus, use of the present system directly reduces the population of the pathogen-carrying adults, in addition to exterminating the larval pre-adults. In other applications, the present automated misting system can be equally effective at dispensing insect repellants. Automated misting system 200 generally comprises a secure controller unit 250 and dispersing elements 220. Controller unit 250 includes a weatherproof and secure enclosure which houses the controller, pump, pesticide reservoir and power source for delivering controlled amounts of a pesticide mixture to nozzles 224 of dispersing elements 220 via permanently installed tubing 222 (or riser). Automated misting system 200 can be attached to any number of nozzles 224, but four or five nozzles are usually adequate for treating the refuse collection area of a restaurant, or the like, containing a MGB, wherein there is a substantial amount of new refuse deposited on a nearly hourly basis.

The present system is a battery-powered automatic misting system for controlling flying and crawling insects using an insecticide or repellant. Generally, the system is comprised of a timer/pump assembly which is powered by a DC battery (such as a commonly available 12-volt, 18-volt, 24-volt, or other voltage) along with a chemical reservoir. The components are mounted in a weatherproof locking enclosure that can be semi-permanently affixed to a wall using fasteners. The present self-contained, automatic misting system is a system is designed for fly and odor control, usually in a commercial environment, but the system is versatile enough to be used for controlling insects in barns, trash receptacles and even patio areas. Once the enclosure is securely mounted on a wall, an outlet to the pump is coupled to a series of tubes and nozzles. The nozzles are strategically positioned around the perimeter of an area where control of insects is desired and, typically, are oriented to mist a height frequented by flying pests. The timer is programmed to initiate the pumping cycle several times a day, during periods when the pests are most active. Additionally, the pumping cycle may be initiated by remote control using a hand-held transmitter. The insecticide in the reservoir is premixed to a predetermined concentration for the application. The insecticide retained in the reservoir may be any of a number of types, that is selected for use in a particular application based on the seriousness of the infestation, the proximity to humans, pets and other wildlife and the federal and local pesticide use ordinances. The pump draws the insecticide mix from the reservoir and pumps it through the tubing dispensing it through the misting nozzles. When used as described above, the present invention achieves up to 98 percent control of the insect population. Coincidentally, it has been postulated that an adult fly infestation can be up to 18 times worse than predicted, because for every fly observed in an area, 17 others are present but go undetected.

In certain applications, the above described system may utilize the external reservoir that is attached to the timer/pump assembly as described above. This embodiment is particularly useful in applications where additional spray nozzles are necessary for treating a larger area. This type of application may include a backyard of a home, around a commercial building, barns or multi-family dwellings.

In accordance with still another exemplary embodiment of the present invention, the inlet end of a proportioning injector may be coupled to a water supply and the outlet end is attached to the timer/pump assembly. All of the system components are mounted in an outdoor locking enclosure that can be attached to a wall.

This system can be attached to any number of nozzles. This system will be used in residential applications where there is a desire to eliminate the external reservoir.

The presently described invention is different from that known in the prior art in its battery-powered operation. The present invention eliminates the need for 110 or 220-volt line power sources, and therefore can be located in areas where line current is not available, such as refuse collection buildings, outbuildings, on comfort stations and barns and stables, in addition to other typical locations such as homes, restaurants, pools, common areas in condos and apartments. Because the present invention does not utilize a high voltage power source, it is far safer and can be used in close proximity to water sources without conflicting with local building codes and safety ordinances. Conversely, the present invention does not utilize a pressurized water source for achieving misting pressures. Thus, the presently described battery-powered automatic misting system is also more versatile than that known in the prior art. Since the product operates without the need of an external power source, it can be used in virtually any location where an infestation may occur. Furthermore, the battery may be replaced as needed, usually simultaneously with refilling the pesticide reservoir, or instead may be charged conventionally using an onboard low voltage line charger or a solar panel.

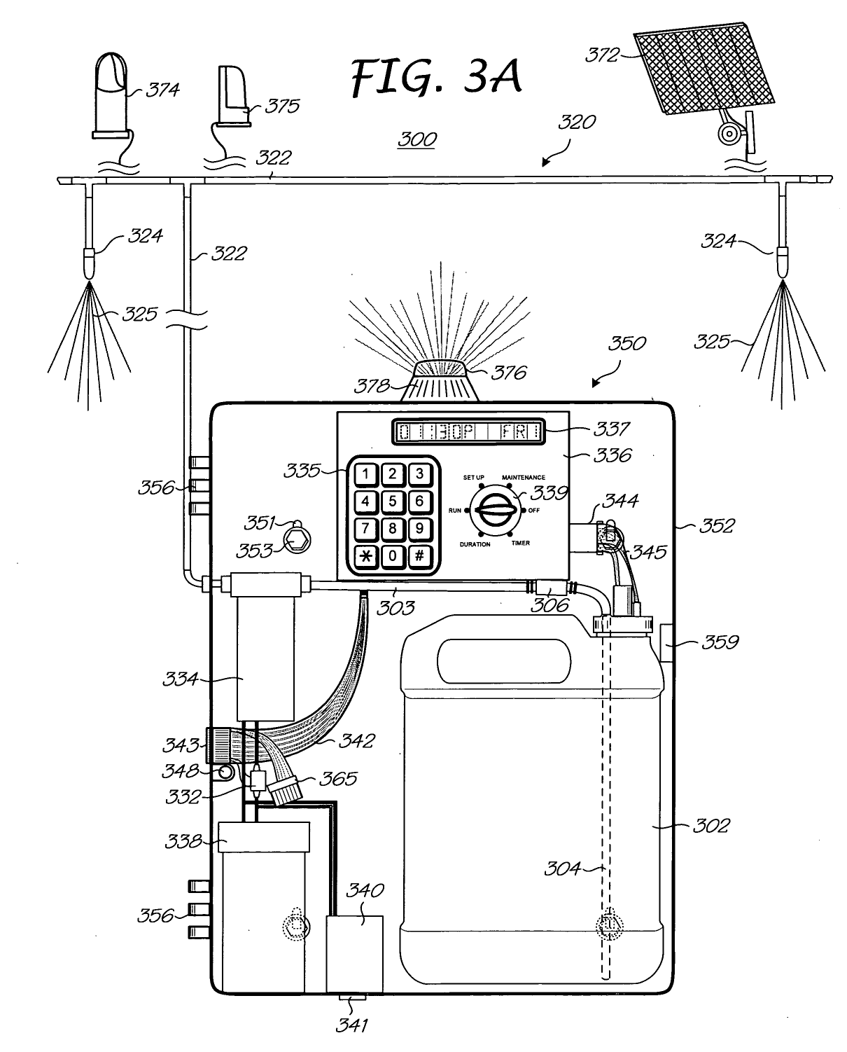

The structure and operation of an exemplary embodiment of the present invention will be appreciated through a discussion of the automated misting system illustrated in FIGS. 3A and 3B. Automated misting system 300 generally comprises two subcomponents, controller unit 350 and dispersing elements 320. Dispersing elements 320 includes risers and tubing 322 for routing the pressurized pesticide to nozzles 324 and dispensing same as pesticide mist 325, as generally discussed above. The location and orientation of tubing 322 and nozzles 324 depends on the particular application, i.e., the location, infestation type and proximity to other living creatures. As a practical matter, nozzle 324 should be selected based on the mist pattern it produces and the flow amount as nozzle can disperse. For flying pests, a fine mist is much more effective and has the added advantage having a relatively low dispersion rate, for example a system designed to use five misting nozzles, each having a 0.012 inch orifice, and using a 2½ gallon reservoir will last approximately thirty-four days between refills (an optimal combination for a 30-day maintenance schedule).

Controller unit 350, on the other hand, is far different from that known in the prior art in that controller unit 350 is a self-contained reservoir system for automated misting of pesticides for the efficient control of adult population. Certain components require protection from the weather and/or should be secured from access by the general public. Thus, controller unit 350 includes a weatherproof enclosure of enclosure cabinet 352 and sealing door 354, which is pivotally attached to cabinet 352 by hinges 356. Cabinet 352 and door 354 may be any type of wall mounted storage cabinet and made of any high impact nonreactive material such as PVC, or ABS plastics, fiberglass or acrylic. Cabinet 352 may be fitted with a plurality of mounting holes 351 for securing the enclosure to a permanent structure by receiving mounting fasteners 353 and should have a volume sufficient to comfortably house a 2 or 2½ gallon container (however, any size removable container may be used that is suitable for holding pesticides, or alternatively, the container can be integrated in the structure of cabinet 352), reservoir 302, along with battery 338, pump 334 and programmable controller 336. Additional space should be provided between pump 334 and other heat sensitive components, as well as for performing routine maintenance such as interchanging and refilling reservoir 302. Battery 338 may be any of a variety of DC batteries (such as a commonly available 12-volt, 18-volt, 24-volt, or other voltage that is compatible with the pump), but should be rechargeable. Also, because of the proximity to pesticide vapors and sparkling at the pump motor brushes, a sealed dry cell type battery is preferable over a wet cell, although either type will suffice. Recharging unit 240 may also be provided recharging battery 338, an external port for connecting an AC source should be provided for convenience, or alternatively, an external DC port may be provided for connecting an external recharging unit. The heart of controller unit 350 is programmable controller 336, which receives programming instructions from the operator on keypad 335 and, using onboard programming and logic, schedules misting cycles, monitors time and a variety of inputs from various sensors and, based on the information from the sensors and the misting schedule, initiates the misting sequence. Programmable controller 336 may include a microprocessor, clock, controller interfaces and ROM and RAM type memories as necessary for storing, reading and writing program code, data and time/dates for executing the timing sequence and self-checks. Programmable controller 336 may instead be configured as a timer for setting a mist schedule, either manually or electronically. A battery backup may be provided for programmable controller 336 for retaining programming instruction, timing and misting schedules and the like in case the primary battery 338 fails or is temporarily disconnected. Programming, maintenance and running modes may be selected using rotary switch 339 and the user inputs and other values monitored on display 337, which may be any type of single/multiline readout or display, such as LCD or LED.

Programmable controller 336 sends and receives signals from other onboard components using one or more data busses, usually secured to the backplane of cabinet 352, shown here as data bus 342 and reservoir bus 345. This bus configuration is merely exemplary and is used herein only to describe aspects of the present invention. Data bus 342 terminates at outer connector 343, which is used for electrically coupling programmable controller 336 to external sensors, switches and communication components. Data bus 342 also provides conductors for a switching current to pump control switch 332 for completing a conducting path to battery 338 that energizes pump 334 and draws pesticide from reservoir 302, via inlet tube 303. Pump control switch 332 is typically a relay or solid state device in which the high current path necessary for operating pump 334 is connected directly to the pump rather than through programmable controller 336.

Pump 334 should have a rating in excess of 100 psi to assure that a flowing pressure of 100 psi can be maintained in dispersing elements 320 during misting operations. Typically, a rating of 130 psi will suffice for a site having five of fewer nozzles. However, the pressure requirement for larger systems increases with the number of nozzles employed and the distance to the pump (resulting from pressure losses in the tubing). For example, a pump rating of 160 psi is sufficient for supporting misting in up to 60 nozzles while a pump rating of 250 psi is adequate for supporting misting in 100 nozzles.

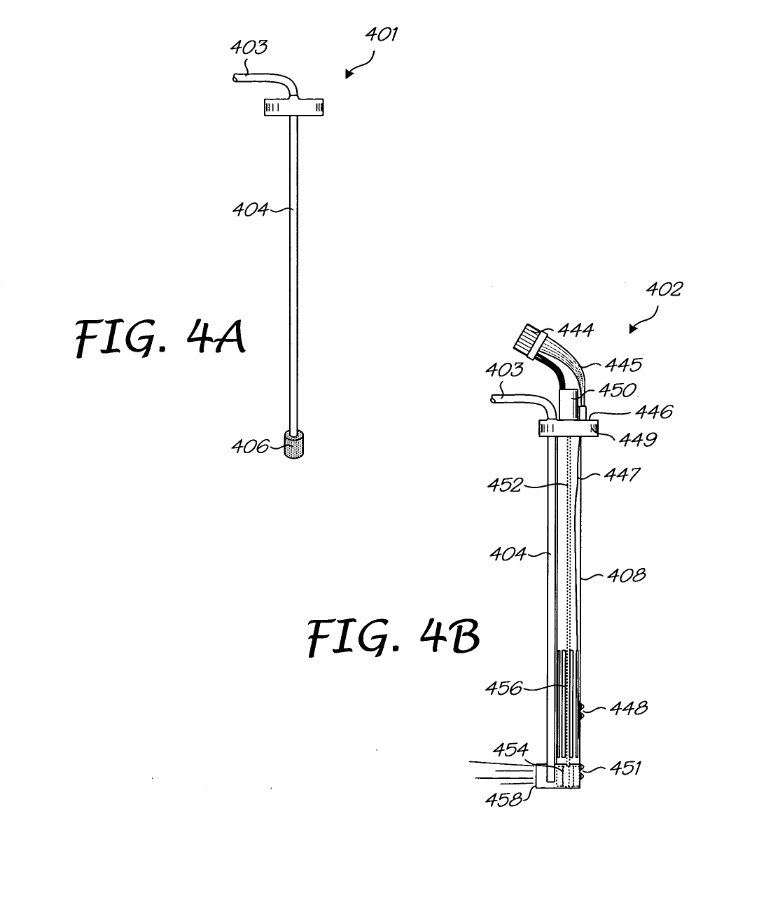

The present invention does more than merely dispense pesticides on a predetermined schedule, but intelligently mists an area based on several dynamic variables. These include: the state and operational status of the system; the presence or absence of non-pest living organisms; and weather conditions. These will be discussed below with regard to FIGS. 5-8, however certain sensing devices may be incorporated, either internally or externally for sensing information used by programmable controller 336 in deciding whether or not to mist at a pre-programmed spray time. For example, weather sensor 374 senses the current weather condition and passes that information on to programmable controller 336. It is important to mist only when pests are active and when the misting will be effective against the pests. Therefore, weather conditions that do not favor pest activity should be recognized to avoid wasting the pesticide product. One metric of pest activity is light, most fly colonies are active only in the daylight hours, so a light sensor would provide information to programmable controller 336 that would preclude misting during darkness, for instance, if the misting schedule is incorrectly programmed, extremely overcast, or darkness due to shorter days after the summer solstice that has not been reconciled in the mist schedule. A second metric is wind speed. Clearly, misting operations will be ineffective in wind speed, or gusts, above a predetermined threshold amount, for example a threshold of approximately 8 mph with a reset speed of approximately 3 mph. Upon receiving information that the wind speed is above the threshold, programmable controller 336 disables the misting operation until wind conditions are more favorable. Programmable controller 336 may either cancel any misting that is scheduled during a period where wild speed exceeds the wind threshold, or may instead delay the misting for a predetermined time period until the wind speed drops below the threshold. Additionally, misting operations will be ineffective during precipitation events, therefore a third metric is rain detection. Here again, if weather sensor 374 passes information to programmable controller 336 that rain is falling, the controller cancels. Another metric that is indicative of pest activity is the temperature. Many insects are more active at certain temperatures and inactive outside that temperature span. Thus, misting is ineffective. For example, many types of adult flies are inactive in temperatures below 45° F. (7.2° C.), and therefore, if weather sensor 374 passes information to programmable controller 336 indicating the outside temperature is not within the tolerance of the adult population, misting operations should be suspended during those periods. Another metric under investigation is barometric pressure. It has been established that certain insects can sense change in barometric pressure that may indicate the onset of severe weather. Some species of pests become extremely active at the onset of a drop in barometric pressure in foraging and egg laying. If those periods of activity can be predicted by programmable controller 336, the misting schedule can be dynamically adjusted to kill pests during periods of heightened activity brought about by a perceived change in the weather. Thus, weather sensor 374 passes barometric pressure information to programmable controller 336, which compares the information to pressures that are known to result in increased activity of adult insects. If all other conditions are favorable, e.g., light, wind, rain, system status, etc, programmable controller 336 may trigger an immediate misting sequence.

Returning to enclosure 352, other conductors may be provided for signaling the position of door switch 348 to programmable controller 336 and for connection 365 for coupling to external control panel 360 located on the outer side of enclosure door 354. External control panel 360 provides a means for monitoring the status of programmable controller 336, as well as an interface for communication certain user commands to programmable controller 336. For instance, visible on external control panel 360 are status indicator lights 364 representing the state of programmable controller 336, for instance status indicator lights “ON,” “LOW FLUID,” “FAULT,” and “OFF.” Using these indicator lights, anyone can quickly assess the health and status of the controller without any training whatsoever. As depicted in the figure, the ON indicator light is burning indicating that rotary switch 339 is in the RUN position, the system is active and functioning normally. If, however, either the FAULT or LOW FLUID indicator light is glowing, a service person should be contacted to ascertain the source of the fault or to refill reservoir 302. The FAULT indicator light is activated any time that programmable controller 336 senses an internal error, such as low voltage condition, an empty pesticide reservoir, memory glitch or loss, etc. If the OFF indicator light is glowing, the system has been shut down by the operator using rotary switch 339 and the system is in an inactive operational state.

External control panel 360 also provides a mechanism for someone in the vicinity of the spray nozzles to temporarily disable the misting cycle, i.e., by depressing manual delay button 362. Oftentimes, a worker may be emptying refuse into the MGB during a misting cycle. As will be appreciated from the discussion below, the pesticides typically employed with the present invention provide a negligible risk to the worker, but all the same, contact with the skin, eyes and other organs should be avoided. Thus, upon entering the refuse collection area the worker merely depresses manual delay button 362 to ensure the next misting sequence will be delayed for a predetermined time period (for example, for one minute). The worker can then be assured he can go about emptying the refuse and exit the area before the next misting. Another safety feature of the present invention that will be discussed in greater detail with regard to FIGS. 5, 6 and 8 below is audible and visual alarms that warn of an impending misting. Thus, unit 350 is fitted with warning light 376 and audible alarm 378 which are both coupled to programmable controller 336. Warning light 376 may be any intense light of high visibility color, preferably with a rotating beam and/or flashing, such as a strobe light. Audible alarm 378 should be loud but not ear splitting loud, and preferably accelerate the cadence pitch or cycle temporarily corresponding to the approach of the misting cycle. For example, one minute prior to the misting, warning light 376 will flash and audible alarm 378 will ring. As the misting time gets closer, the tempo and/or level of the audible alarm increases, as may the intensity of misting warning light 376. The warnings continue until the misting ceases. In this way, someone working proximate to automated misting system 300 will have more than sufficient time to depress manual delay button 362 as many times as necessary to complete the work. Also present on external control panel 360 is manual test switch 366, for testing the system once the enclosure is locked and programmable controller 336 is inaccessible. As depicted, manual test switch 366 may take the form of a keyed switch to prevent unauthorized persons from activating the test feature. Notice also that the manual test function will initiate a five second delay to allow the operator sufficient time to vacate the area of the misting prior to the misting actually commencing.

Additionally, programmable controller 336 may be coupled to a wireless receiver (not shown) for receiving instructions from a remote wireless transmitter. It is well understood that the activity level of certain pests is heightened by human presence, i.e., the pests become agitated or stirred. Therefore, the period immediately after refuse is deposited in MGB 266 is one of the most active periods for adult flies. In order to allow for a controlled, yet manual misting sequence, a wireless transmitter (not shown) may be employed by the employee after depositing the refuse. Typically, the transmitter is maintained in a secure location, such as inside the premises, but available to the employee for activating a misting sequence. Obviously, the same principle can be employed using manual test switch 366 by authorizing the employee to carry the key to keyed switch 366 or to dispense with the keyed switch in favor of an unsecured manually activated button.

Reservoir 302 contains a sufficient amount of pesticide mixture to enable automated misting for approximately one month between service calls. The exact number of misting supported by the amount of pesticide in reservoir 302 will vary depending on mist times entered by the operator at programmable controller 336. The misting schedule (time and duration) is dependent on two variables: pest pressure (population); and habits. For example, flies are usually more active from around 11 am to 4 pm, however in some cases flies are more active during the early morning hours and will nest around the dumpster surround at night. Thus, the first step is always to investigate the site by inspecting the area and assessing the habits of the target pest. Obviously, some amount of training may be necessary to more accurately assess the pests' habits from a single site inspection. Optimally, a 2½ gallon reservoir system is designed to mist for a total of one minute per day (this assumes that five or fewer nozzles are used). This will ensure that the system will not run out of product for one month. This fits into the monthly pest control program of most commercial establishments. Given the parameters mentioned above, the operator can program mist schedules for any combination of one total minute of misting time, for instance two mistings per day at 30 seconds each, or four mistings a day for fifteen seconds each, and so on as long as the maximum amount of misting times is one minute. Systems with more than eight nozzles should have an exterior reservoir to avoid having to fill the system too often. The more nozzles used on the system, the more product will be dispensed. Typically, there are some constraints on programming the mist schedule at programmable controller 336, for instance, misting times are limited to 16 discreet times a day with a maximum mist duration of 30 seconds for each mist. This is a function of the hardware timer or software application loaded on programmable controller 336 and may be altered, however, some constraints should be established to prevent over-misting an area.

Reservoir 302 may be filled with a variety of different insecticide, pesticide and repellent types, and may have an added fragrance or deodorizer for fumigating the refuse area. Several pesticides and repellents are currently on the market that can be used in this system, but it should be understood that the present invention is not dependent on any one type of pesticide, insecticide, insecticide classification or group of insecticides. Those of ordinary skill in the art will recognize that, for various reasons, the type of pesticide, insecticide, insecticide classifications or groups of insecticides will change and some will become unavailable, while others will come on the market for use. The present invention is versatile enough to support any type of pesticide, insecticide and/or repellent due to its nearly infinite programming options and dispersal configurations.

Currently, Pyrethrins are the most widely used variety of products; they are also the most preferred. Pyrethrins come from Pyrethrum, which is extracted from the chrysanthemum flower. These products have no long-term residuals meaning they will start to break down within minutes of being misted. This aids against insect resistance as well as human exposure to the pesticide. Permethrins are also labeled for use in the system. Permethrins are the synthetic version of Pyrethrins. They have a great kill rate and can be used in an area of high pest pressure. Permethrins however have a residual effect, which can linger in the area long after it is applied. This can lead to insect resistance and chemical exposure to workers. If this product were to be used it is recommended for a one-time use for a particularly serious infestation. Once the pest infestation is controlled, the system should be refilled with Pyrethrins.

Furthermore, the U.S. Environmental Protection Agency (EPA) has exempted certain products that are becoming more accepted for use in the Pest Management Industry. Some of these products are labeled for use in the system. Historically, the exempt products have not preformed well, however new products are being made with natural food grade materials that are showing great results. They are also a good fit because there is no residual and so far no insect resistance to these natural products.

As mentioned elsewhere above, unlike other automated misting systems, the present invention utilizes reservoir 302 with a pre-measured and premixed pesticide product, rather than a concentrate that must be diluted with water during the application of the product. Mix rates of all of the above-mentioned products will vary depending on the particular product and the application of the product. It is important to read the chemical label to determine the proper dilution before mixing and using the products. These rates will differ for each product based on the type of pest to be controlled. They will also have a higher rate for problem areas and a lower rate for maintaining control.

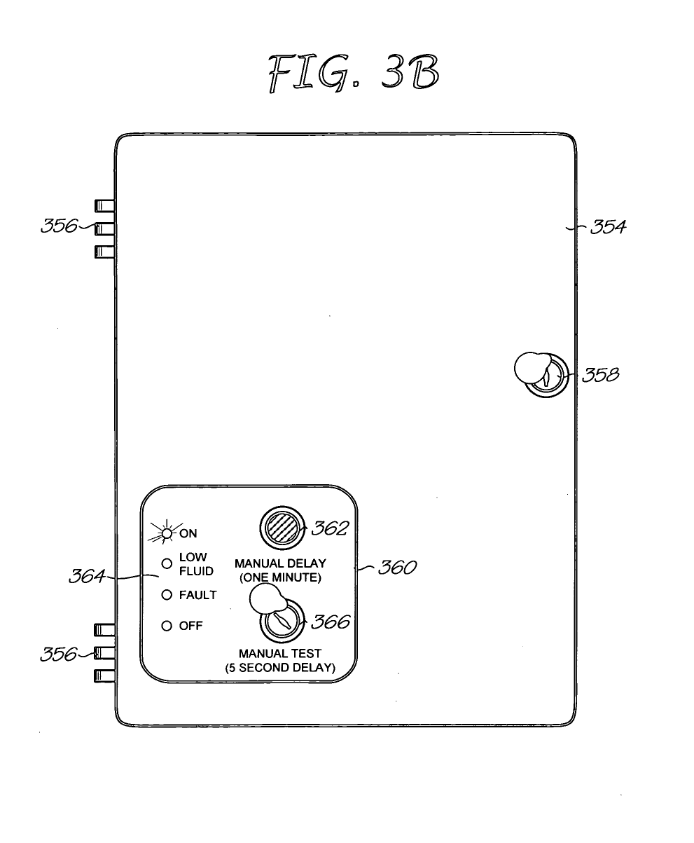

In accordance with one exemplary embodiment of the present invention, pesticide is drawn from reservoir 302 through suction tube 304 and ported through cap 446 (depicted as 404 in FIGS. 4A and 4B). Typically, a filter is installed either on suction tube 404 shown as submersible filter 406 or on inlet tube 303 depicted as external filter 306. The filter prevents congealed pesticide and other foreign matter from clogging nozzles 324 or damaging pump 334. However, because reservoir 302 contains a pre-mixed dilation of pesticide and water, some settling may occur between mistings. Therefore, and in accordance with one exemplary embodiment of the present invention, reservoir 302 may be fitted with an agitator for stirring the pesticide mixture prior to each misting (see FIGS. 4A and 4B). The agitator will include agitator motor 450, shaft 452 and agitator impeller 454 disposed within reservoir 302 near the bottom. Agitator impeller 454 may be an exposed “pinwheel” type, or may be contained in agitator housing 408 with agitator intake slots 456 for receiving fluid and agitator outlet 458 for exhausting the fluid at some velocity for mixing. Agitator motor 450 receives power and/or run signals from programmable controller 336 over bus 345 (445 on FIG. 4B), and may be easily uncoupled for refilling reservoir 302 using connection 344 (444 on FIG. 4B). Threaded ring 349 (449 on FIG. 4B) is also provided on cap 446 for tightening cap 446 to the spout of reservoir 302 while enabling the operator to open reservoir 302 without twisting the wires in reservoir bus 345.

In accordance with one exemplary embodiment of the present invention, a fluid sensor may be disposed along either suction tube 404, agitator housing 408, or on some other structure with the volume of reservoir 302. As depicted, two sets of sensors may be employed. Low fluid sensors 448 are positioned at the low fluid level of reservoir 302 and when uncovered by the pesticide, indicate to programmable controller 336 that the pesticide level should be checked and refilled. Upon sensing a low fluid condition, programmable controller 336 will activate the “LOW FLUID” external indicator light 364. Empty sensors 451 are positioned at the empty fluid level of the reservoir and when uncovered, empty sensors 451 indicate to programmable controller 336 that the fluid is empty. Upon sensing an empty fluid condition, programmable controller 336 will immediately suspend misting operations and activate the “FAULT” external indicator light 364.

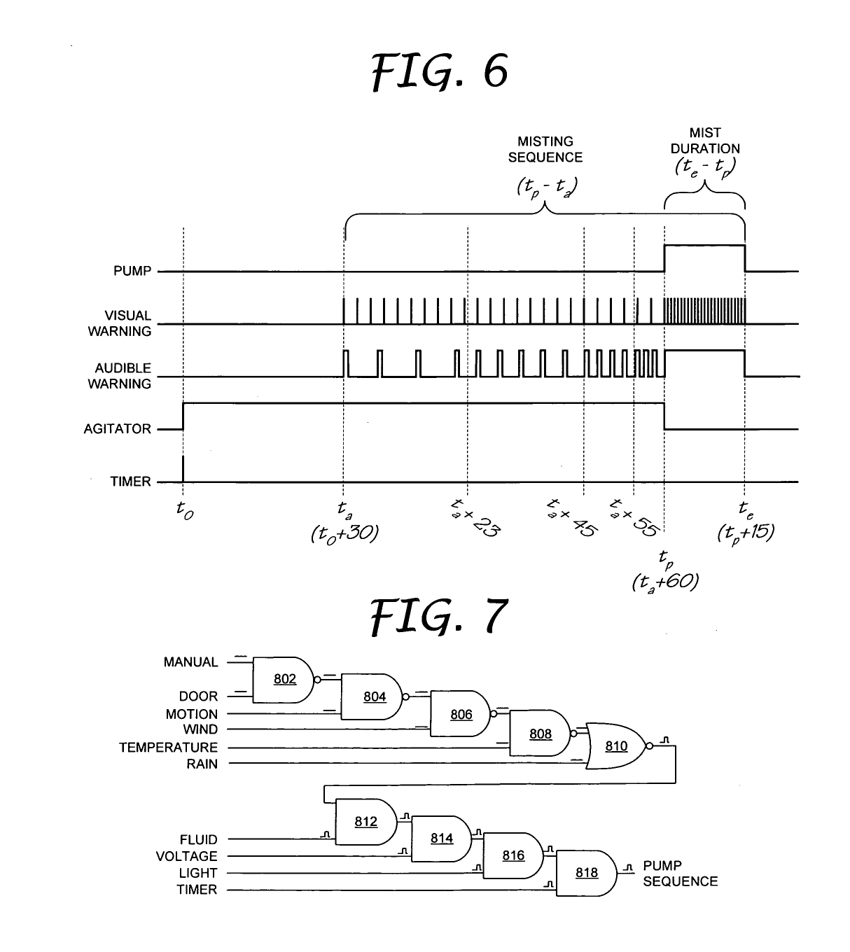

Turning now to FIG. 5 an exemplary timing sequence is shown for misting operations in accordance with one exemplary embodiment of the present invention. The timing diagram depicts timing traces for each of PUMP, TEMPERATURE, WIND, RAIN, DOOR, MOTION, MANUAL, FLUID, VOLTAGE, LIGHT, and TIMER plotted against time. Parameters other than those mentioned above may also be included or one or more mentioned above may be dispensed without departing from the scope or spirit of the present invention. The current misting schedule calls for a misting sequence to be initiated at each of scheduled times t₁ through t₆. At any time t₀ in which TIMER indicates a misting sequence should proceed, programmable controller 336 makes a series of self-checks to determine if it is safe to mist and if the misting will be efficient. For instance, programmable controller 336 determines if it is currently light outside, LIGHT is TRUE (high or low whichever indicates light intensity over a predetermined intensity threshold) and if the battery voltage is sufficient for completing the misting operation, VOLTAGE is also TRUE (operating pump 334 without sufficient voltage may damage the motor windings). With regard to the figures, logical TRUE is the high condition and logical FALSE is the low condition on the traces. FLUID is also checked or a TRUE condition. If LIGHT=TRUE and VOLTAGE=TRUE and LIGHT=TRUE when TIMER=TRUE, the self-check can proceed, otherwise the self-check ceases until the next occurrence of t₀. These may be logically tested as logical ANDs (see logical diagram in FIG. 7 with ANDs 812, 814, 816 and 818).

Next, a series of conditions are tested that, if TRUE the misting sequence ceases. The first three are safety conditions, MANUAL, MOTION and DOOR, if either is TRUE programmable controller 336 infers that a life form other than a pest is present within the refuse area and misting operations should be suspended until the condition is FALSE. It should be understood that some motion detectors will sense a change in temperature for the misting operation as motion and send a false indication to programmable controller 336. The signals from motion detector 375 may be suppressed during misting, however that has the unwanted effect of continuing misting when someone walks into the refuse area. A better solution it to select motion detectors that are insensitive to the misting operation. In addition, open sensors may be installed on storage area doors 262 and 264 that indicate a door is open or ajar which must also be FALSE. The next three traces in FIG. 5 represent weather safety conditions: RAIN, WIND and TEMPERATURE. If all three are FALSE, misting can proceed, otherwise the self-check ceases until the next t₀ where TIME equals TRUE. These may be logically tested as logical NANDS 802, 804, 806 and 808 that output is connected to NOR 810 (see FIG. 7).

The misting sequences at times t₁ through t₆ can be followed logically and the reasons for canceling a misting cycle be determined. For instance, at time t₁ MOTION and RAIN both equal TRUE so the misting self-check is aborted for time t₁. At time t₂ DOOR equals TRUE indicating that someone has door 354 to enclosure 352 open, consequently the self-check is again aborted. However at time t₃, LIGHT=TRUE and VOLTAGE=TRUE and LIGHT=TRUE and MANUAL=FALSE and MOTION=FALSE and DOOR=FALSE and RAIN=FALSE and WIND=FALSE and TEMPERATURE=FALSE, therefore PUMP=TRUE. As a practical matter, the self-checking sequence of programmable controller 336 may be embodied as hardware or firmware or as a software object loaded on to ROM or RAM memory.

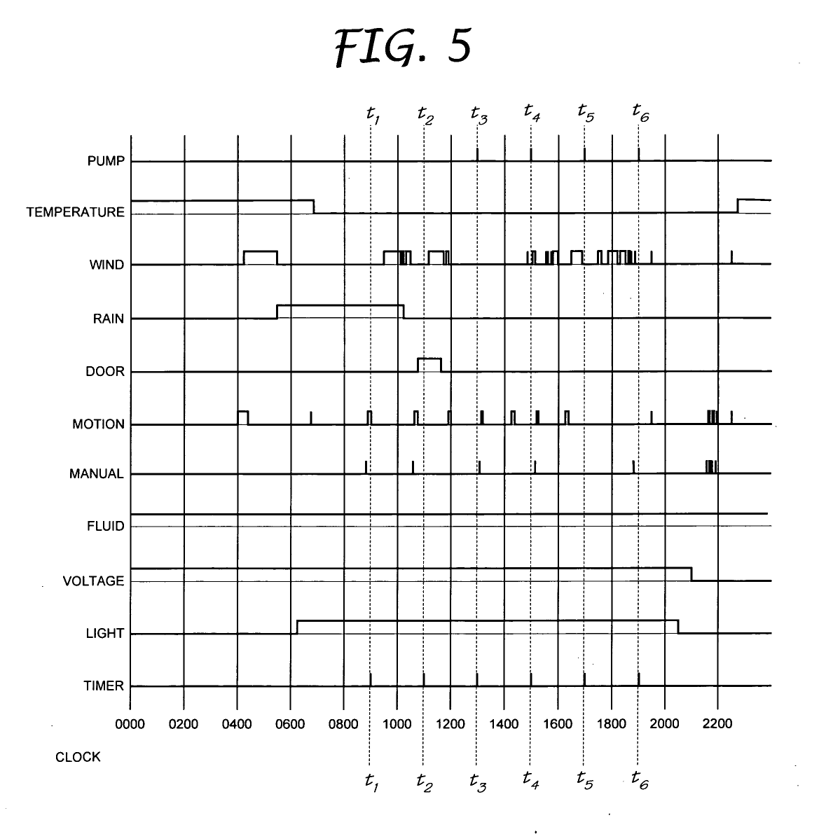

Turning now to FIG. 6, an exemplary timing diagram for a misting sequence is shown in accordance with one exemplary embodiment of the present invention. The timing diagram depicts timing traces for each of PUMP, VISUAL WARNING, AUDIBLE WARNING, AGITATOR and TIMER between times t₀ and tₑ. Programmable controller 336 recognizes the start of a mist sequence at time t₀ and energized agitator motor 450; AGITATOR=TRUE. Some time period after the fluid agitation has commenced, at time tₐ, programmable controller 336 energizes warning light 376 and audible alarm 378, VISUAL WARNING=TRUE and AUDIBLE WARNING=TRUE. Typically, the agitator motor 450 runs for at least 60 seconds prior to energizing pump 334 in order to sufficiently agitate the pesticide (as depicted in the figure, agitator motor 450 runs for 15 seconds prior to the alarms, but may run longer if the alarm period is shortened i.e., tₐ=tₒ+30). At time tₐ+12, the cadence of the audible alarm increases and increases again at times tₐ+23, tₐ+45, tₐ+55, and tₐ+60. This particular mist sequence is depicted as having a 60-second warning period; however, as a practicable matter a 15-second warning period gives a more urgent sense to take immediate action. The visual alarm may also flash on with increased intensity and/or frequency. At time tₚ the alarms are at their peaks and pump 334 is energized for a misting duration of between 15 and 30 seconds (shown here as 15 seconds). At this time, agitator motor 450 is de-energized so that the entire resource of battery 338 can be devoted to pumping. At time tₑ the misting sequence terminates, PUMP, VISUAL WARNING and AUDIBLE all go FALSE and the misting sequence ends.

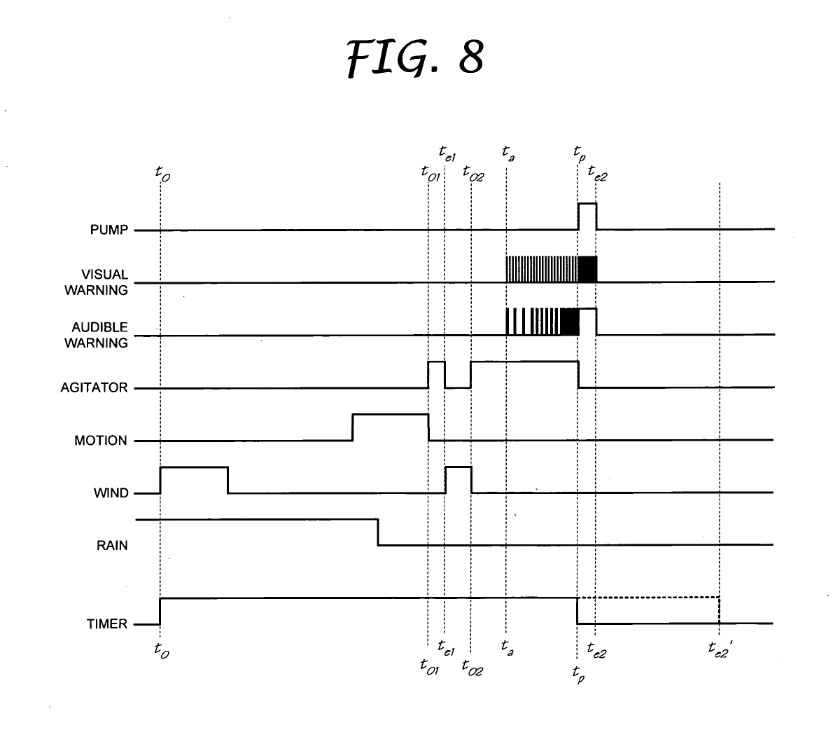

Turning now to FIG. 8, an exemplary timing sequence for the intelligent scheduling of a misting sequence is shown in accordance with one exemplary embodiment of the present invention. Previously discussed, programmable controller 336 would proceed through a series of self-checks at each time t₀ and based on the outcome of the tests would initiate the misting sequence, or not. Thus, according to that protocol, t₀ is merely a trigger to the sequence that may be disregarded. However, if a cycle is missed, misting is postponed until the next occurrence of a scheduled time t₀. According to another exemplary embodiment of the present invention, time t₀ represents a window in which the misting sequence can proceed if all conditions are in agreement.

The timing diagram of FIG. 8 depicts timing traces for each of PUMP, VISUAL WARNING, AUDIBLE WARNING, AGITATOR and TIMER as in FIG. 6, however here they are shown between times t₀ and tₑ₂′. In this case, TIMER opens a window between times t₀ and tₑ₂′ in which the misting sequence can proceed if all of the conditions for misting are in agreement. For instance, at time t₀ TIMER is high indicating that condition is TRUE; however RAIN and WIND are also high indicating that condition is TRUE also. PUMP will remain low while MOTION, WIND and/or RAIN are TRUE, and therefore, the misting sequence cannot proceed. As time progresses, WIND goes low and RAIN also goes low in the interval where TIMER remains high, but MOTION also goes high. At time t₀₁ all of MOTION, WIND and RAIN are FALSE and TIMER is high so the misting sequence commences with AGITATOR going high (agitator motor 450 is energized). However, at time tₑ₁, and before the alarm sequence can commence, WIND goes high causing AGITATOR to go low, thereby reenergizing agitator motor 450. Note however, TIMER remains high during this period enabling the misting sequence to restart if all of the conditions for misting are in agreement, which occurs at time t₀₂. The misting sequence proceeds as discussed above with regard to FIG. 6 until time tₑ₂, when PUMP goes low. Notice here at tₑ₂, PUMP going low also brings TIMER to the low state, thereby preventing another misting sequence from commencing in the same time window. If a time=tₑ₂′ before the misting cycle commences, misting for that scheduled time interval t₀ will be skipped.

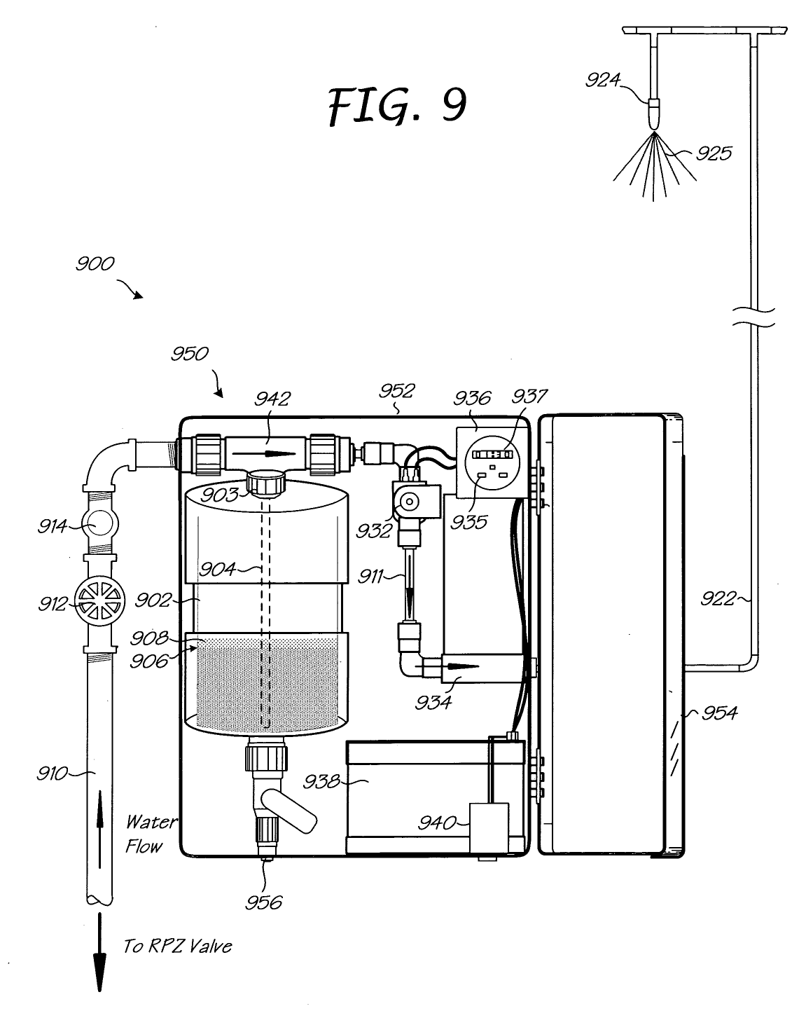

In accordance with another exemplary embodiment of the present invention, greater capacity may be achieved by using concentrated pesticide in a pesticide reservoir and by mixing the concentrate with water from pressurized water source with an injector that is serially connected to a pump. FIG. 9 is a diagram depicting a self-contained reservoir system for automated misting of pesticides, safely, for efficient control of pests in accordance with an exemplary embodiment of the present invention. Here, controller unit 950 generally comprises weatherproof enclosure 952 and sealing door 954 for holding reservoir 902, injector 942, pump 934, solenoid valve 932, battery 928, and programmable controller 936.

Pump 934 should have a rating in excess of 100 psi to assure that a flowing pressure of 100 psi can be maintained in dispersing elements 920 during misting operations. Typically, a rating of 130 psi will suffice for a site having five of fewer nozzles. However, the pressure requirement for larger systems increases with the number of nozzles employed and the distance to the pump (resulting from pressure losses in the tubing).

Pump 934 is connected between the low pressure side of solenoid valve 932 and the dispersing elements, e.g., tubing 922 and nozzles 925. Solenoid valve 932 may be any type of electrically operable valve or regulating device that can reliably regulate the flow of water from injector 935, such as a ball, gate or diaphragm valve which operates by means of a solenoid, actuator, motor or other electromechanical device. Optimally, solenoid valve 932 should not react with the pesticide in reservoir 902 or the minerals in the water from source 910.

A pressurized water source 910 provides fresh water to controller unit 950 through safety valve 912 and check valve 914. (typically a reduced pressure zone (RPZ) valve is also installed further upstream which provides additional protection from potential contamination). Pressurized water floods the cavity of injector 942 and any air-filled voids in reservoir 902 (with the pesticide), and into the tubing between injector 942 and normally closed solenoid valve 932. An equilibrium state is achieved in which reservoir 902, injector 942 and the tubing to the back side of solenoid valve 932 are all at the pressure of the water supply 910. In the equilibrium state, the fluid is motionless. Rather than containing a diluted pesticide mixture, reservoir 902 holds concentrated pesticide. Typically, the concentrated pesticide held within reservoir 902 is either more or less dense than water, causing the concentrated pesticide and water to separate into distinct strata when in the equilibrium state. If the concentrated pesticide is denser than water, the concentrated pesticide will migrate to the bottom portion of reservoir 902, below pesticide stratum level 906 (above which is stratum 908 comprised of a relatively thin stratum of diluted pesticide). Therefore, the opening of suction tube 904 should be located within the pesticide stratum. If the concentrated pesticide is more dense than water, the opening of suction tube 904 should be positioned proximate to the bottom of the reservoir (as depicted in the figure), alternatively, if the concentrated pesticide is less dense than water, the opening of the suction tube should be positioned near the top of reservoir 902. In cases where the concentrated pesticide is less dense than water, it is sometimes desirable to route suction tube 904 to the bottom and then back to the top portion of the reservoir rather than merely truncating the suction tube near the top of the reservoir. Additionally, and as will be discussed below, because the pesticide that is drawn out of the reservoir is replaced by water from the injector, it is also preferable to provide a replenishment tube to the bottom of the reservoir which allows the more dense replacement water to fill from the bottom, thereby minimizing unwanted mixing with the concentrated pesticide.

Programmable controller 936 is electrically connected to battery 938 for power, but may also include a battery backup in case battery 938 fails. Programmable controller 936 includes, or is coupled to a switching mechanism (internal or external to controller 936). The switch (not shown) is a relay or solid state device in which the high operating current for operating pump 934, is regulated. Solenoid valve 932 is also connected to the switch (and/or controller 936) and connected parallel in with pump 934. Battery 938 may be any of a variety of DC batteries, as discussed elsewhere above, in any commonly available voltage that is compatible with the pump and preferable a sealed dry cell type battery. Misting schedules are programmed into programmable controller 936 using buttons 935 and the times and other information may be verified using display 937.

Although not specifically depicted in the figure, system 900 may be configured with any or all of the external components as discussed above with respect to FIGS. 3A and 3B, including, for example, weather and motion sensors and a solar cell for recharging battery 938. Optional onboard recharging unit 940 may also provided and optimally includes an external port for connecting an AC source, or, alternatively, a DC port may be provided for connecting an external recharging unit.

Programmable controller 936 monitors time and other parameters for determining optimal conditions for misting. Once programmable controller 936 decides conditions favor misting, programmable controller 936 simultaneously directs power to both solenoid valve 932 and pump 934 (for example, via a control signal to the switching mechanism). Normally-closed solenoid valve 932 becomes energized, causing the valve to open, and the pressurized water and pesticide flows into pump 934, which is also energized and operating. Pump 934 draws water from water supply 910 and across injector 935. Injector 942 is a venturi-like device. As water flows across injector 942, a low pressure is created that draws concentrated pesticide from internal reservoir 902 (by suction tube 904) and through a calibrated metering orifice of the injector and into the water in the body of the injector, but at a rate determined by the size of the metering orifice. The concentrated pesticide and water mix in the body of injector 942 and are drawn to pump 934. Once in pump 934, the pressure of the mixture is increased from a pressure approximately equivalent to that of the municipal water (65 psi or less), to over 100 psi which is optimal for producing mist 925 (rather than a spray stream), and exhausts the mixture through outlet tube/riser 922 to the dispersing elements.

As should be appreciated, the present invention has all of the advantages of the control unit discussed above with respect to FIGS. 3A and 3B, but with drastically increased capacity. However, servicing control unit 950 requires a technician to refill pesticide reservoir 902 with concentrated pesticide. Recall that as the concentrated pesticide is drawn out of reservoir 902 it is replaced by water. Thus, reservoir 902 is never empty, but full of water that must be replaced by concentrated pesticide. This is accomplished by switching controller 936 to OFF or MAINTENANCE and then closing valve 912. With a recovery container attached to drain valve 954, the valve is opened slowly, allowing the pressurized water to drain into the recovery container. After the pressure is released, refill cap 903 is loosened and the remaining fluid will pour into the recovery container and drain valve 954 closed. The recovery container is uncoupled form drain valve 954, sealed and disposed of properly. With reservoir 902 empty, pesticide can be refilled in reservoir 902 through the opening beneath cap 903. Care should be taken to avoid overfilling. Once complete, cap 903 is replaced, tightly, and valve 912 is opened slowly to allow the internal pressure to reach equilibrium. Finally, controller 936 is switched back to RUN and cabinet door 954 closed and locked.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A self-contained reservoir system for automated misting of pesticides, comprising:
an enclosure, said enclosure having a cabinet with an interior volume;
a pump disposed within the interior volume of the cabinet, said pump having an inlet for receiving a liquid and an outlet for exhausting the liquid;
a battery;
a switch disposed within the interior volume of the cabinet, said switch being electrically coupled between the pump and the battery;
a timer disposed within the interior volume of the cabinet, said timer being electrically coupled to the switch;
a reservoir having a volume for holding liquids, said reservoir being hydraulically coupled to the inlet of the pump;
a dispersing port for traversing the enclosure, said dispersing port being hydraulically coupled to the outlet of the pump; and
at least one dispersing element, said at least one dispersing element hydraulically coupled to one of the dispersing port and the outlet of the pump.

2. The system recited in claim 1 further comprises:
a kill switch exposed outside the enclosure, said kill switch being electrically coupled between the pump and battery.

3. The system recited in claim 1 further comprises:
a kill switch exposed outside the enclosure, said kill switch being electrically coupled to the timer.

4. The system recited in claim 1, further comprises:
a programmable controller disposed within the enclosure, said programmable controller including said timer.

5. The system recited in claim 4, further comprises:
a kill switch exposed outside the enclosure, said kill switch being electrically coupled to the programmable controller.

6. The system recited in claim 4, wherein the programmable controller further comprises:
a user interface; and
a display.

7. The system recited in claim 4 further comprises:
a wireless receiver, said wireless receiver being at least partially disposed within the volume of the cabinet and electrically coupled to the programmable controller.

8. The system recited in claim 4 further comprises:
a fluid level sensor, said fluid level sensor being at least partially disposed within said reservoir and electrically coupled to said programmable controller.

9. The system recited in claim 1, further comprises:
a recharging unit, said recharging unit being electrically coupled to said battery.

10. The system recited in claim 1, further comprises:
a solar cell, said solar cell being electrically coupled to said battery.

11. The system recited in claim 1, further comprises:
an agitator, said agitator being at least partially disposed within said reservoir.

12. The system recited in claim 1, wherein the timer further comprises:
a user interface for entering misting times.

13. The system recited in claim 1 further comprises:
at least one indicator light, a level sensor, said at least one indicator light being visible on an exterior surface of the enclosure.

14. The system recited in claim 1, wherein the pump further comprises capacity for exhausting a liquid at a pressure greater than 65 pound per inch² at the outlet.

15. The system recited in claim 1, wherein the pump further comprises capacity for exhausting a liquid at a pressure greater than 100 pound per inch² at the outlet.

16. The system recited in claim 1, wherein the at least one dispersing element further comprises a misting nozzle, said misting nozzle having an orifice of 0.012 or less.

17. The system recited in claim 1, wherein the at least one dispersing element further comprises:
a plurality of misting nozzles, each of said misting nozzles having an orifice of 0.012 or less; and
tubing, said tubing coupled between each of said misting nozzles and one of the dispersing port and pump.

18. The system recited in claim 1, wherein the dispersing port is one of a tube and a fitting.

19. The system recited in claim 1, wherein the enclosure further comprises:
a cabinet door, said cabinet door covering said interior volume of said cabinet.

20. The system recited in claim 18 further comprises:
a lock disposed on one of said cabinet and cabinet door for engaging the cabinet to the cabinet door.

21. A self-contained reservoir system for automated misting of pesticides, comprising:
an enclosure, said enclosure having a cabinet with an interior volume;
an injector within the interior volume of the cabinet, said injector having an injector inlet for receiving a liquid into a body cavity, an orifice for receiving a second liquid into the body cavity and an injector outlet for exhausting a mixture of the first and second liquids;
an electrical pump disposed within the interior volume of the cabinet, said electrical pump having an inlet for receiving a fluid and an outlet for exhausting the fluid;
a reservoir having a volume for holding the second liquid, said reservoir being hydraulically coupled to the injector;
a dispersing port for traversing the enclosure, said dispersing port being hydraulically coupled to the outlet of the electrical pump;
a battery;
an electrically operable valve, said electrically operable valve being hydraulically coupled between the injector outlet and the inlet of the electrical pump;
a timer disposed within the interior volume of the cabinet, said timer being electrically coupled to the electrically operable valve and to the electrical pump; and
at least one dispersing element, said at least one dispersing element hydraulically coupled to the outlet of the electrical pump.
